(19) United States
(12) Patent Application Publication
(10) Pub. No.: US 2006/0185371 A1
(43) Pub. Date: Aug. 24, 2006

(54) Quenchline exit plenum for a cyrogenic unit

(75) Inventors: Stephen Paul Trowell, Finstock (GB); Keith White, Abingdon (GB)

Correspondence Address: CROWELL & MORING LLP;INTELLECTUAL PROPERTY GROUP, P.O. BOX 14300, WASHINGTON, DC, 20044-4300, US

(73) Assignee: Siemens Magnet Technology Ltd., Oxford (GB)

(21) Appl. No.: 11/180,604

(22) Filed: Jul. 14, 2005

(30) Foreign Application Priority Data
Feb. 21, 2005 (GB) 0503530.8

(51) Int. Cl. F17C 7/04; F17C 9/02; F25B 19/00

(52) U.S. Cl. 62/48.1

(57) ABSTRACT

A quench line and exit plenum configuration for a mobile MRI system housed in a transportable trailer includes an exit plenum with deflector plates that direct the quench flow of cold gases upward and away from surrounding objects. In addition, the plenum also includes dual vents to facilitate optimum gas flow and water drainage. The deflector plates are configured to utilize the Venturi effect to create an auxiliary flow of the ambient air to help deflect the flow of cold gases away from nearby pedestrians, when the magnet is quenching, and to enable service personnel to fill the magnet safely while in the vicinity of the exit plenum.

The present invention is directed to a quench line and plenum arrangement for a mobile MRI system of the type which is generally housed in a trailer.

### BACKGROUND OF THE INVENTION

Magnetic Resonance Imaging (“MRI”) systems require the generation of an extremely strong magnetic field, which is generally measured in units referred to as “Tesla”. (One Tesla=10,000 Gauss.) In order to achieve a magnetic field of this strength, it is generally necessary to employ superconducting magnets, which include coil windings that are cooled to temperatures on the order of a few degrees above absolute zero, using liquid helium as a coolant in the form of a cryogenic bath. Aside from the difficulties posed by the intense magnetic field itself, the handling of large quantities of such extremely cold liquid helium poses certain inherent difficulties.

One such difficulty is associated with the quenching of the superconducting coils of the magnet. “Quenching” in this context refers to a sudden loss of superconductivity in the wire that makes up the superconducting coils. As the coils start to exhibit normal resistive behavior, they heat up, causing the process to accelerate, so that the liquid helium “boils” off rapidly, releasing the magnet's stored energy in a process that can become somewhat violent. Moreover, the large volume (thousands of cubic meters) of evaporated liquid helium, which is released rapidly via a quench line remains extremely cold, and can cause injury, including “cold burns”, to anyone who comes into contact with it. Asphyxiation is also a hazard.

Quenching may be performed intentionally, such as when it becomes necessary to shut down the magnetic field in order to prevent personnel or patient injury, or it may occur spontaneously due to a failure in the magnet system itself or an external influence. In either case, it is apparent that the manner in which the resulting discharge of evaporated helium gas is guided and vented to the exterior is extremely important. In particular, the design of the so-called “quench line” is significant, and must be configured so as to minimize the risk that people, animals or damageable objects will come into direct contact with the gas discharge. Moreover, it is also essential that the quench line be capable at all times of venting the evaporated helium at a rate that accommodates the rapid boiling in the cryogenic unit. If, for example, the quench line is inadequate or becomes constricted or clogged, a particularly dangerous situation can result. One such possibility is that moisture accumulates in the quench line, blocking it and causing helium gas to be vented into the examination area, which can result in asphyxiation.

Mobile MRI systems of the type mentioned previously are subject to all of the considerations described above, and in addition present their own unique design problems as well. For example, there is an increased risk of a spontaneous quench of the cryogenic cooling system due to “jostling” of the mobile MRI device between field locations. In addition to mechanical vibrations, systems are exposed to varying electromagnetic environments during transport which can also induce a quench. In addition, the necessity for movement of the trailer along routes populated by other vehicles is also of concern. For example, if the trailer is in a line of traffic, with a bus immediately behind, passengers at the front of the bus on the upper floor might be at risk of personal injury from cold gas in the event of a magnet quench. Similar risks have been identified to personnel working on ladders or raised platforms behind a mobile MRI system which is installed at a site. In order to address safety risks to service personnel, known mobile MRI systems have been designed to be refilled with liquid helium by service personnel located outside and to the rear of the trailer/housing, beneath the quench line exit.

To deal with these considerations, the exit of the quench line for mobile MRI systems must meet the following criteria:
Provide a safe means of venting helium gas from the helium vessel under magnet service and quench conditions;
Not generate a significant pressure drop, or restrict the gas flow;
Inhibit the ingress of rain water, wind-borne debris and wildlife;
Allow any water in the quench line to drain away;
Be compatible with maximum trailer dimensions and national regulations regarding appendages to the exterior of the trailer;
Minimize cost to manufacture; and
Minimize the requirement for internal space within the trailer.

Conventional horizontal quench line exits do not direct quench flow gas away from pedestrians or bus passengers. During magnet depressurization and filling, air cooled by the released helium gas could impinge on service personnel beneath the exit grill. If the inner surface of the quench line exit is not angled downwards, condensation will reside in the quench line, with serious consequences if this migrates to the quench valve assembly.

Covers have been fitted to the exterior of horizontal quench line exit grills on previous MRI mobile installations, primarily to prohibit the ingress of rainwater. These designs were not favored by trailer manufacturers since appendages to the trailer are limited by road regulations (maximum trailer width), and compact cover designs can lead to large pressure drops for the quench gas flow. Hinged covers over exit grills are not permitted for any MRI installations (mobile or static) within the guidelines provided by Siemens Magnet Technology for quench line design (830-105HB2).

### SUMMARY OF THE INVENTION

In view of the above safety concerns, one object of the present invention is to provide a quench line and exit plenum for a mobile MRI system, which exhibit an improved design with regard to venting of helium gas.

Another object of the invention is to provide such a quench line and exit plenum which reduces the risk to individuals close to the trailer when the cryogenic system quenches.

These and other objects and advantages are achieved by the quench line and exit plenum arrangement according to the invention, which includes an exit plenum with deflector plates that direct the quench flow of cold gases upward and away from surrounding objects. In addition, the plenum also includes dual vents to facilitate optimum gas flow and water drainage. The deflector plates are configured to utilize the Venturi effect to create an auxiliary flow of the ambient air, which combines with the cold gas flow, and helps to deflect it away from nearby pedestrians when the magnet is quenching, and to enable service personnel to fill the magnet safely while in the vicinity of the exit plenum.

### BRIEF DESCRIPTION OF THE DRAWINGS

FIG. 1 is a side view of the quench line/exit plenum according to the invention, which shows the gas flow under magnet venting conditions;

FIG. 2 is similar to FIG. 1, and shows water drainage via the plenum; and

FIG. 3 is a perspective view of the exit plenum according to the invention, viewed from inside the trailer of a mobile MRI system.

### DETAILED DESCRIPTION OF THE DRAWINGS

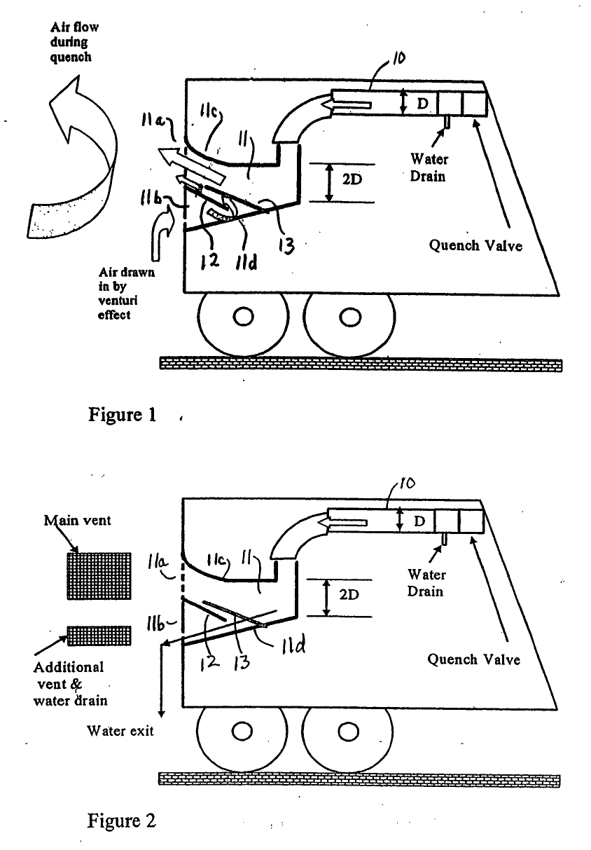

FIGS. 1-3 illustrate a preferred embodiment of the quench line/exit plenum arrangement according to the invention, in which the system is vented to the exterior at the rear of the trailer that houses it.

FIG. 1 shows quench line 10 and exit plenum 11 mounted in a trailer which houses a mobile MRI system. In order not to restrict gas flow, for a quench line of diameter D, the plenum should be of minimum depth 2D. The plenum has two exit grills. The main vent 11a is sized for the quench flow. For safety reasons, gas flow is directed through this vent at an angle of approximately 45° to the vertical by two overlapping deflectors plates 12 and 13 and a curved upper surface 11c.

The secondary vent 11b and angled lower surface 11d enable effective water drainage from the plenum (FIG. 2). Holes in deflector plate 13 prevent water from collecting upstream of this plate. The deflector plates ensure that cold gas flow is not directed down towards pedestrians through the secondary vent grill when the magnet is venting. Furthermore, the overlap between deflector plates 12 and 13 generates a low pressure region by virtue of the Venturi effect, which draws air in through the secondary vent whenever cold gas exits the main vent, compounding the effect of deflecting the main gas flow upwards.

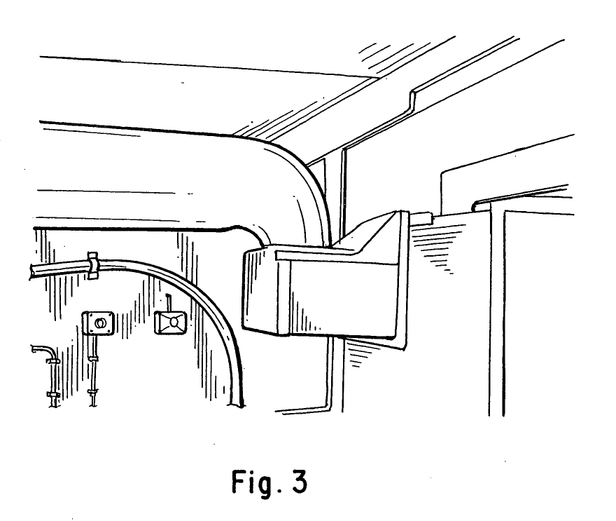

The plenum according to the invention was fitted to a mobile system, built by Medical Coaches, Oneonta, N.Y. It was mounted inboard so that there were no appendages to the rear of the trailer (FIG. 3). Alternative embodiments may include use of a single large vent grill; it is not essential to the operation of the plenum that two grills be used. Any means of water drainage through deflector plate 2 in FIG. 2 may be used, such as a small gap under the plate as well as, or instead of, holes in the plate. The plenum could be used on side exit quench lines, where space permits, as well as for rear exit quench lines. Embodiments of the design could apply to static installations, to improve safety related to the quench gas.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Apparatus for venting evaporated coolant from a cryogenic unit housed in a mobile trailer, comprising:
a quench line for receiving a flow of evaporated coolant gas from said cryogenic unit during a quench thereof; and
a plenum coupled to said quench line and opening to an ambient environment surrounding said trailer via a main vent and a secondary vent; wherein
said main vent is separated from said secondary vent by first and second deflector plates mounted in said plenum;
said deflector plates cooperate with a curved upper interior surface of said plenum to deflect said gas flow in an upward direction relative to a surface that supports the trailer, as said gas exits the plenum;
said first and second deflector plates overlap each other and are separated by a gap which connects said secondary vent with said main vent, whereby during an outward flow of evaporated gas from said cryogenic unit via said main vent, ambient air is drawn into said secondary vent, flows through said gap into said main vent, and is combined with said outward flow.

2. The apparatus according to claim 1, wherein said cryogenic unit is part of a mobile MRI system housed in said trailer.

3. The apparatus according to claim 1, wherein said deflector plates have openings that permit water to drain from said plenum along a downwardly sloping lower inner surface of said plenum.

4. The apparatus according to claim 3, wherein said openings in said deflector plates comprise holes having a size that permits water to flow through, but do not divert said flow of coolant gas.

5. The apparatus according to claim 1, wherein said deflector plates deflect said gas flow upwardly at an angle of at least about 45° relative to horizontal.

6. The apparatus according to claim 1, wherein said plenum opens to said ambient environment through one of a side wall and a rear wall of said trailer.

7. Apparatus for venting evaporated coolant from a cryogenic unit installed in a housing defined by front, side and rear walls, said apparatus comprising:
a quench line coupled to said cryogenic unit;
a plenum coupled to said quench line and opening through a wall of said housing to an exterior of said housing; and
deflectors arranged in said plenum for deflecting a flow of evaporated coolant from said quench line upwardly as it exits said plenum through a main vent;
wherein said deflectors define and separate a secondary vent in said plenum, and include an air flow path by which ambient air can be drawn into said plenum via said secondary vent and mix with said flow of evaporated coolant via said air flow path.

8. The apparatus according to claim 7, wherein said cryogenic unit is part of a mobile MRI system housed in said trailer.

9. The apparatus according to claim 7, wherein said deflector plates have openings that permit water to drain from said plenum along a downwardly sloping lower inner surface of said plenum.

10. The apparatus according to claim 9, wherein said openings in said deflector plates comprise holes having a size that permits water to flow through, but does not divert said flow of coolant gas.

11. The apparatus according to claim 7, wherein said deflector plates deflect said gas flow upwardly at an angle of at least about 45° relative to horizontal.

12. The apparatus according to claim 7, wherein said plenum opens to said ambient environment through one of a side wall and a rear wall of said housing.

13. A plenum for venting an evaporated coolant flow from a quench line for a cryogenic unit housed in a mobile trailer, comprising:
a chamber adapted to receive said evaporated coolant flow from said quench line, and guide it to an exterior of said trailer;
first and second deflector plates disposed in said chamber, for deflecting said evaporated coolant flow upwardly relative to a surface that supports the trailer, as said evaporated coolant exits the chamber via a first vent of said chamber;
a second vent of said chamber delineated from said first vent by said first and second deflector plates;
wherein said first and second deflector plates overlap each other and are separated from each other by a gap which forms a gas flow path connecting said first and second vents, whereby ambient air can be drawn into said second vent and flow through the gap into the first vent during an outward flow of evaporated coolant through said plenum during a quenching of said cryogenic unit.

14. The apparatus according to claim 13, wherein said cryogenic unit is part of a mobile MRI system housed in said trailer.

15. The apparatus according to claim 13, wherein said deflector plates have openings that permit water to drain from said plenum along a downwardly sloping lower inner surface of said plenum.

16. The apparatus according to claim 15, wherein said openings in said deflector plates comprise holes having a size that permits water to flow through, but does not divert said flow of coolant gas.

17. The apparatus according to claim 13, wherein said deflector plates deflect said gas flow upwardly at an angle of at least about 45° relative to horizontal.

18. The apparatus according to claim 13, wherein said plenum opens to said ambient environment through one of a side wall and a rear wall of said trailer.

19. The plenum according to claim 13, wherein said first and second deflector plates are disposed in approximately parallel spaced apart relationship in an area of said overlap, said spacing apart forming said gap.

20. The plenum according to claim 19, wherein said gap draws ambient air into said second vent using the Venturi principle.
